(19) United States
(12) Patent Application Publication
(10) Pub. No.: US 2009/0322118 A1
(43) Pub. Date: Dec. 31, 2009

(54) Water Shield With Integrated Modular Sealing

(75) Inventor: Chi H. Koa, West Bloomfield, MI (US)

Correspondence Address: HARNESS, DICKEY & PIERCE, P.L.C., P.O. BOX 828, BLOOMFIELD HILLS, MI, 48303, US

(73) Assignee: FOAMADE INDUSTRIES, INC., Auburn Hills, MI (US)

(21) Appl. No.: 12/145,941

(22) Filed: Jun. 25, 2008

(51) Int. Cl. E06B 7/16; B60J 5/00

(52) U.S. Cl. 296/146.7; 49/506; 49/489.1

(57) ABSTRACT

A method of manufacturing a door for a vehicle may include forming an interior panel having a geometry including contours and vehicle accessories disposed thereon; forming a foam member having a varying thickness coinciding with the geometry of the interior panel, the foam member being resiliently compressible; retaining a moisture shield against the foam member; fixing the foam member to the exterior-facing side of the interior panel, the varied thickness of the foam member being aligned with the geometry of the exterior-facing side of the interior panel; and fixing the interior panel to the exterior door, the foam member resiliently biasing the moisture shield against an interior-facing side of the exterior door. The moisture shield, the foam member, and the interior panel form a pre-assembled module prior to fixing the interior panel to the exterior door.

### FIELD

The present disclosure relates to a door assembly for a vehicle and more particularly to a foam member for sealing a water shield within the door assembly and a method of assembling the door assembly.

### BACKGROUND

The statements in this section merely provide background information related to the present disclosure and may not constitute prior art.

A door assembly for a vehicle often includes a sheet metal and/or polymeric exterior door panel and a polymeric interior panel. The exterior panel typically supports a window and a mechanism for raising and lowering the window. The window may be slidably raised and lowered within a cavity in the exterior door panel. As such, water may seep around the window and into the cavity within the exterior panel and may accumulate therein.

The interior panel may support various vehicle accessories, including, for example, door lock mechanisms, wiring for power window actuation systems, stereo speakers, and/or other mechanical and electrical components. As such, it may be necessary to include a water barrier to shield the interior panel and the components supported thereon from water and/or moisture that may accumulate within the exterior panel.

The present disclosure provides a foam member for retaining the moisture barrier (or moisture shield) to the interior panel to form a module. The module may be sealed against the exterior panel to prevent moisture from contaminating electrical and mechanical components supported within the door assembly. A method of manufacturing the door assembly for a vehicle having the foam member and moisture shield is also provided.

### SUMMARY

A method of manufacturing a door for a vehicle may include forming an interior panel, an exterior-facing side of the interior panel having a geometry including contours and vehicle accessories disposed thereon; forming a foam member having an inner periphery and an outer periphery, the foam member having a varying thickness coinciding with the geometry of the exterior-facing side of the interior panel, the foam member being resiliently compressible; retaining a moisture shield against the foam member, an interior-facing side of the moisture shield being adhesively retained against the foam member; fixing the foam member to the exterior-facing side of the interior panel, the varied thickness of the foam member being aligned with the geometry of the exterior-facing side of the interior panel; and fixing the interior panel to the exterior door, the foam member resiliently biasing the moisture shield against an interior-facing side of the exterior door. The moisture shield, the foam member, and the interior panel form a pre-assembled module prior to fixing the interior panel to the exterior door.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic cross-sectional view of a door assembly according to the principles of the present disclosure;

FIG. 2 is a perspective view of an exterior-facing side of an interior door panel and a foam member of the door assembly of FIG. 1;

FIG. 3 is a schematic partially exploded cross-sectional view of a pre-assembled module according to the principles of the present disclosure;

FIG. 4 is a schematic cross-sectional view of the pre-assembled module according to the principles of the present disclosure;

FIG. 5 is a perspective view an exterior door panel having a moisture shield and foam member fixed thereto according to the principles of the present disclosure;

FIG. 6 is a schematic cross-sectional view of the door assembly according to the principles of the present disclosure;

FIG. 7 is a schematic partially exploded perspective view of the door assembly according to the principles of the present disclosure;

FIG. 8 is an exploded perspective view of an interior panel and another embodiment of the foam member according to the principles of the present disclosure; and

FIG. 9 is a schematic cross-sectional view of an alternative pre-assembled module according to the principles of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

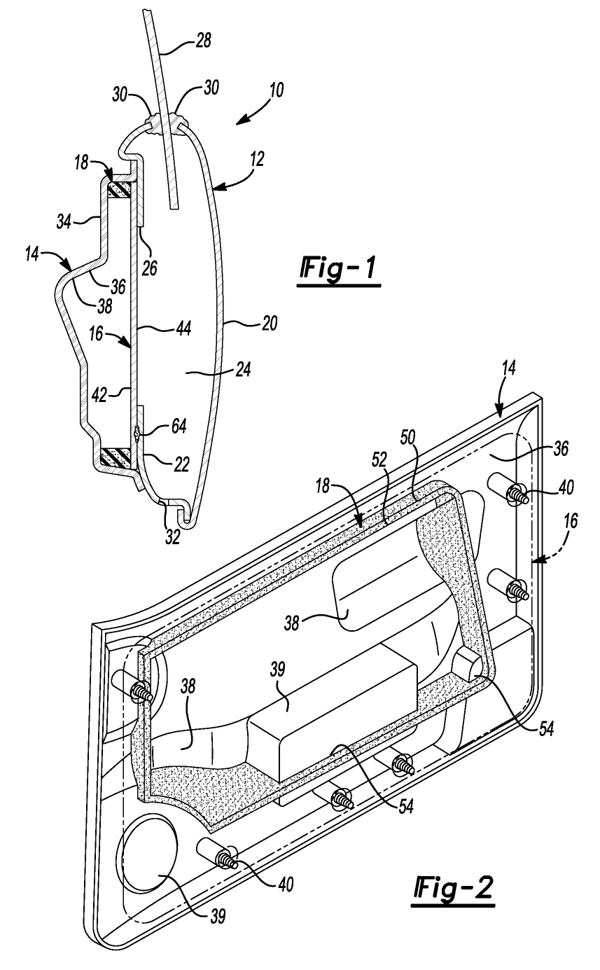

With reference to FIGS. 1-8, a door assembly 10 is provided and may include an exterior panel 12, an interior panel 14, a moisture shield 16, and a foam member 18. The door assembly 10 may be installed on a vehicle (not shown), for example, and may provide a means of ingress and egress therefor. It should be appreciated that the door assembly 10 is not limited to ingress/egress doors, and may include other vehicle closures, such as, for example, liftgates, tailgates, and the like for vans, hatchback vehicles or sport utility vehicles.

The exterior panel 12 may include an outer shell 20 (facing away from the vehicle) and an inner shell 22 (facing the interior of the vehicle) which may be joined together to form a cavity 24 therebetween. The inner shell 22 may include an opening 26 to allow access to the cavity 24.

A window 28 may be slidably supported between window sealing members 30 disposed on each of the outer shell 20 and the inner shell 22. A window actuation mechanism (not shown) may be housed within the cavity 24 and may slidably raise or lower the window 28 within the cavity 24. Since water may enter the cavity 24 around or on the window 28 and accumulate therein, a drainage hole 32 may be provided at the bottom of the exterior panel 12 to allow water to drain therefrom.

The interior panel 14 may be molded or otherwise formed from a polymeric material and may include an interior-facing side 34 (facing the interior of the vehicle) and an exterior-facing side 36 (facing the exterior of the vehicle). The interior panel 14 may have a geometry including a plurality of contours 38 to accommodate vehicle accessories 39 mounted thereto. The vehicle accessories 39 may include, for example, an armrest, a door opening handle, power window switches, power door lock switches, stereo speakers, and other mechanical and/or electrical components known in the art to be disposed on the interior panel 14.

One or more fasteners 40 may be disposed on the interior panel 14 near the periphery of the exterior-facing side 36 (FIG. 2). The fasteners 40 may be matingly received in corresponding apertures in the inner shell 22 of the exterior panel 12, securing the interior panel 14 thereto. The fasteners 40 may be “Christmas tree” fasteners (known in the art) including a stud having a plurality of resiliently flexible barbed protuberances which allow the fasteners 40 to be pressed into a mating hole in the exterior panel 12 to secure the interior panel 14 thereto. The flexible barbed protuberances may securely retain the interior panel 14 to the exterior panel 12, while allowing a service technician, for example, to manually pull and/or pry the interior panel 14 from the exterior panel 12 for access to the components housed therebetween. It should be appreciated that other suitable snap-on fasteners or fastening means may be utilized to secure the interior panel 14 to the exterior panel 12.

The moisture shield 16 may be a flat panel (having a flat cross section) formed from polypropylene, for example, or any other suitable moisture impervious polymer. The moisture shield 16 may include an interior-facing side 42, which is fixed to the foam member 18 (as will be subsequently described), and an exterior-facing side 44, which may be fixed to the inner shell 22 of the exterior panel 12 (as will be subsequently described). As shown in FIGS. 1 and 5, for example, the moisture shield 16 is adhesively sealed over the opening 26 of the inner shell 22 to shield the vehicle accessories, the interior panel and the interior of the vehicle from water and/or moisture.

The moisture shield 16 may include an indented bend or fold line 46 (FIG. 7) which may serve as a hinge for bending the moisture shield 16 to allow access to the cavity 24 and/or the components housed therein, after the moisture shield 16 is attached to the exterior panel 12. One or more slits (not shown) may be cut through the moisture shield 16 to allow wiring or other components to pass therethrough to the interior panel 14, for example.

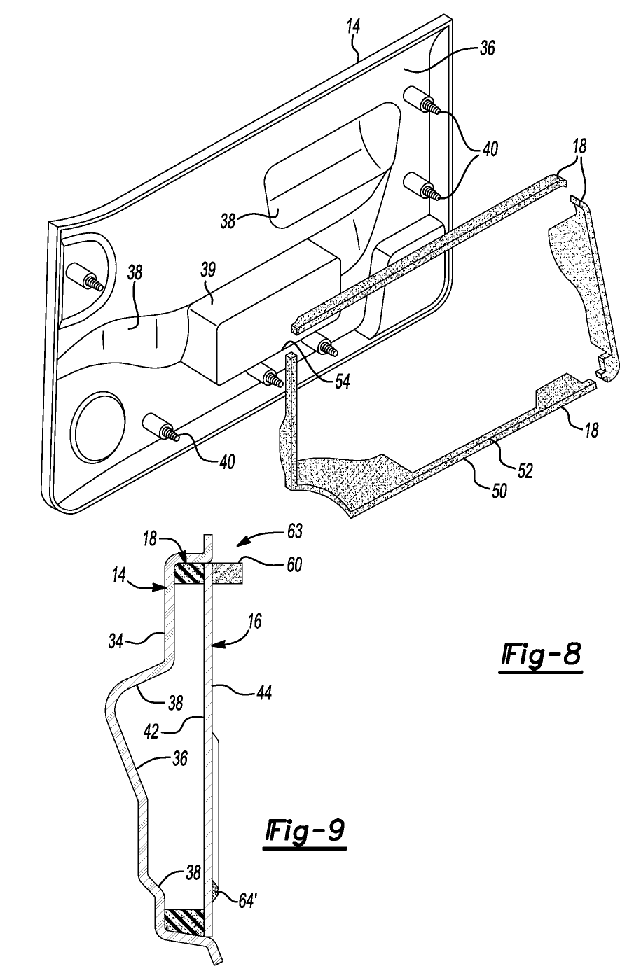

The foam member 18 may be molded, cut, or otherwise formed from a resiliently compressible foam polymer, such as, for example, polyurethane foam. The foam member 18 may include an outer periphery 50 and an inner periphery 52 formed substantially parallel to the outer periphery 50 (FIG. 2). The foam member 18 may form a continuous, 360 degree loop disposed against the interior-facing side 42 of the moisture shield 16 at or near the periphery thereof. It should be appreciated that the foam member 18 could be a discontinuous or broken loop (see, e.g., FIG. 8), i.e., the foam member 18 may be formed from a plurality of foam pieces and/or may extend less than 360 degrees.

The foam member 18 may include a varying thickness which corresponds to the geometry of the interior panel 14 and the accessories 39 supported thereon. Stated another way, the thickness of the foam member 18 may vary to meet a geometry of the contours 38 of the exterior-facing side 36 of the interior panel 14 and the accessories 39.

As shown in FIG. 2, with the moisture shield 16 illustrated in phantom for illustration purposes, the foam member 18 may be disposed against the exterior-facing side 36 of the interior panel 14, the varying thickness of the foam member 18 coinciding with the geometry of the exterior-facing side 36 of the interior panel 14. The foam member 18 may be retained on the interior panel 14 by press fitting one or more portions of the foam member 18 into crevasses 54 (FIGS. 2 and 8) formed by the contoured geometry of the interior panel 14 and the accessories 39 mounted thereto. One or more fasteners, such as, for example, the “Christmas tree” fasteners described above (or other suitable fasteners), may protrude from the interior panel 14 into or through apertures in the moisture shield 16 that is adhered to the exterior-facing side of the foam member 18 to supplement the retaining force of the press fit relationship described above. It should be appreciated that the press fit relationship between the foam member 18 and the interior panel 14 may be sufficient to retain the foam member 18 thereon, minimizing or eliminating the need for supplemental fasteners.

The moisture shield 16 may be adhesively bonded to the foam member 18. The adhesive may be any adhesive adapted to secure the materials of the foam member 18 and the moisture shield 16. Since the cross-sectional geometry of the foam member 18 meets that of the exterior-facing side 36 of the interior panel 14, the moisture shield 16 may be a flat panel and still may be securely retained to the interior panel 14, thereby reducing the cost and complexity of the moisture shield 16. Prior to installation to the exterior door panel 12, and adhesive bead 64 is applied to a perimeter of the exterior-facing side 44 of the moisture shield 16. When the interior panel 14 is secured to the exterior panel 12, the foam member 18 may be resiliently compressed between the exterior-facing side 36 of the interior panel 14 and the interior-facing side 42 of the moisture shield 16, biasing the moisture shield 16 against the inner shell 22 of the exterior panel 12 and causing the adhesive bead 64 to adhere the moisture shield 16 to the exterior panel 12 of the door assembly 10.

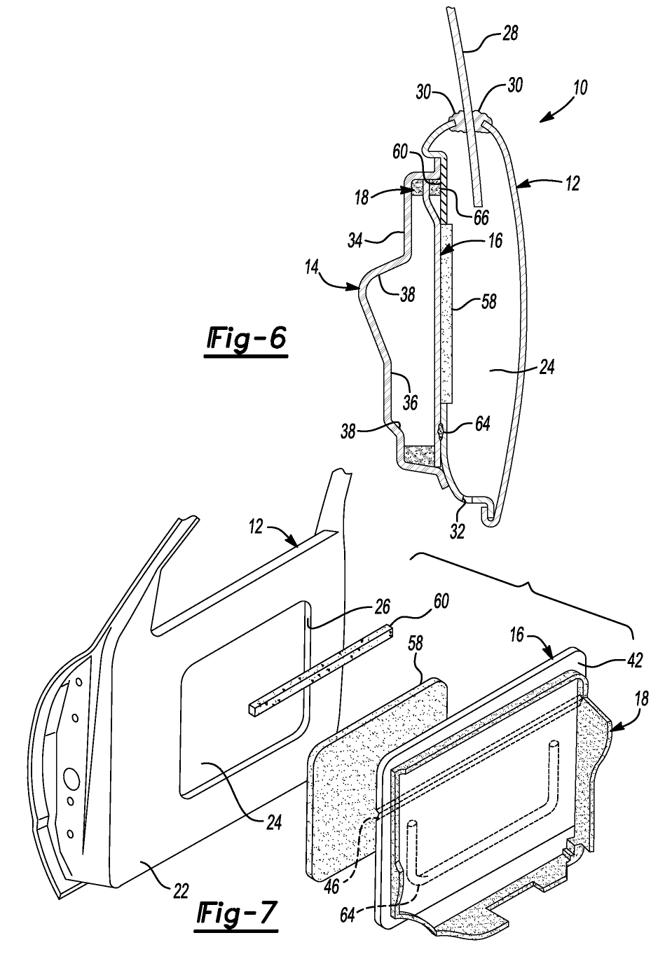

Referring now to FIGS. 6 and 7, the door assembly 10 may also include a sound absorbent panel 58 and a foam strip 60. The sound absorbent panel 58 may be a flat panel formed from a non-woven fabric and/or any suitable sound attenuating polymer. The sound absorbent panel 58 may be adhesively bonded, sonic welded, heat staked, or otherwise suitably attached to the exterior-facing side 44 of the moisture shield 16. The sound absorbent panel 58 may substantially fill the opening 26 in the inner shell 22 of the exterior panel 12 to dampen noises associated with normal driving conditions. The sound absorbent panel 58 may be moisture repellant and may supplement the moisture shield 16 in preventing water and/or moisture from seeping onto the interior panel 14 or into the vehicle.

The foam strip 60 may be a resiliently compressible member formed from polyurethane foam or any other suitable resiliently compressible foam polymer. The foam strip 60 may be adhesively bonded to the exterior-facing side 44 of the moisture shield 16. The foam strip 60 may be resiliently compressed between the moisture shield 16 and the inner shell 22 of the exterior panel 12. In this manner, the foam strip 60 may be a dust and debris barrier, preventing dust or water from inside the cavity 24 from seeping over an upper edge of the moisture shield 16, thereby protecting the electrical and mechanical components mounted to the interior panel 14 from contamination.

Continuing with reference to FIGS. 1-8, a method of assembling the door 10 will be described in detail. First, the foam member 18 may be formed to include the varying thicknesses to match the contoured and crevassed geometry of the exterior-facing side 36 of the interior panel 14 and the accessories mounted thereto, as described above. The foam member 18 is then adhered to the perimeter of the exterior-facing side 44 of the moisture shield 16. The moisture shield 16 and foam member 18 may then be fixed to the interior panel 14 by inserting the fasteners 40 of the interior panel 14 through the apertures in the moisture shield 16 as shown in FIG. 2. The foam member 18 can provide additional retention for the moisture shield 16 by press fitting one or more portions of the foam member 18 into the crevasses 54. As described above, the press fit relationship between the foam member 18 and the interior panel 14 will allow fewer fasteners 40 to be required. In this manner, the moisture shield 16 may be retained to the interior panel 14, forming a pre-assembled module 63 (FIGS. 2 and 4) which may be subsequently installed onto the exterior panel 12. The pre-assembled module 63 may also include the sound absorbent panel 58 and the foam strip 60, which, as described above, may be adhesively fixed to the moisture shield 16.

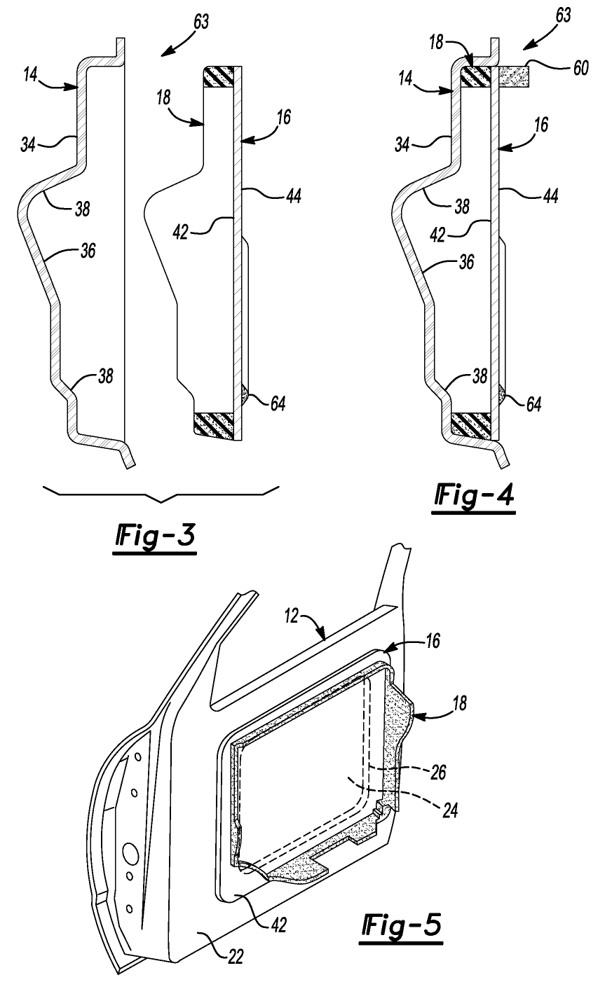

Before the module 63 is installed onto the exterior panel 12, an adhesive strip 64 (shown best in FIGS. 3, 4 and 7) may be applied to the exterior-facing side 44 of the moisture shield 16 (and/or the inner shell 22 of the exterior panel 12). It should be noted that the adhesive strip 64 can be applied to the exterior-facing side 44 of the moisture shield 16 either before or after the moisture shield 16 is attached to the interior panel 14. As the fasteners 40 protruding from the interior panel 14 are engaged with corresponding apertures in the exterior panel 12, the foam member 18 is resiliently compressed between the exterior-facing side 36 of the interior panel 14 and the interior-facing side 42 of the moisture shield 16. The resilient compression of the foam member 18 provides a positive back pressure biasing the moisture shield 16 against the inner shell 22 of the exterior panel 12, thereby wetting out the adhesive 64 therebetween (as shown in FIG. 1), providing a more robust bond and seal between the inner shell 22 and the moisture shield 16. Since the cross-sectional geometry of the foam member 18 matches that of the exterior-facing side 36 of the interior panel 14, the compression of the foam member 18 may be substantially uniform throughout the foam member 18, providing a substantially uniform biasing pressure to the moisture shield 16.

Alternatively, a seal strip 64′ (shown best in FIG. 9) may be applied to the exterior-facing side 44 of the moisture shield 16 (and/or the inner shell 22 of the exterior panel 12). As the fasteners 40 protruding from the interior panel 14 are engaged with corresponding apertures in the exterior panel 12, the foam member 18 is resiliently compressed between the exterior-facing side 36 of the interior panel 14 and the interior-facing side 42 of the moisture shield 16. The resilient compression of the foam member 18 provides a positive back pressure biasing the moisture shield 16 against the inner shell 22 of the exterior panel 12, thereby pressing the seal strip 64′ into sealed engagement between the inner shell 22 and the moisture shield 16. Since the cross-sectional geometry of the foam member 18 matches that of the exterior-facing side 36 of the interior panel 14, the compression of the foam member 18 may be substantially uniform throughout the foam member 18, providing a substantially uniform biasing pressure to the moisture shield 16.

It should be appreciated that the foam strip 60 may provide a sealed relationship between the moisture shield 16 and the exterior panel 12 at a top edge 66 of the interface therebetween (FIG. 6), as the adhesive strip 64 might not extend along the top edge 66. The foam strip 60 may cooperate with the foam member 18 to prevent dust from inside the exterior panel 12 from contaminating interior components.

Although the foam member 18 is described herein as being formed from polyurethane foam, it should be appreciated that the foam member may be formed from any material with sufficient resiliency to apply a sufficient biasing force to the moisture shield 16. The material of the foam member 18 should also have sufficient strength to retain the moisture shield 16 before the module 63 is installed onto the exterior panel 12.

The modular assembly method described herein eliminates the cumbersome task of aligning the moisture shield 16 in its proper position against the inner shell 22 of the exterior panel 12. The module 63 provides the moisture shield 16 in its proper position relative to the opening 26 in the exterior panel 12 as the fasteners 40 protruding from the interior panel 14 are received into the exterior panel 12. The geometry of the foam member 18, described herein as meeting the geometry of the interior panel 14, may also reduce the number of fasteners (or eliminate a need therefor) that may have otherwise been required to retain the moisture shield 16 to the interior panel 14 prior to installation onto the exterior panel 12.

The description of the present disclosure is merely exemplary in nature and, thus, variations that do not depart from the gist of the disclosure are intended to be within the scope of the disclosure. Such variations are not to be regarded as a departure from the spirit and scope of the disclosure.

1. A method of installing an interior panel and a moisture shield onto an exterior door comprising:
forming a foam member to extend substantially around a periphery of a moisture shield, said foam member having varying thicknesses corresponding to a geometry of said interior panel;
retaining said moisture shield against said foam member prior to installation onto said exterior door;
attaching said foam member to said interior panel, said varying thicknesses of said foam member aligning with said geometry of said interior panel; and
attaching said interior panel, said foam member, and said moisture shield to said exterior door, sealing said moisture shield against said exterior door,
wherein said foam member is resiliently compressed between said interior panel and said exterior door, biasing said moisture shield against said exterior door.

2. The method of installing an interior panel and a moisture shield onto an exterior door according to claim 1, wherein said moisture shield is bonded to said exterior door via an adhesive.

3. The method of installing an interior panel and a moisture shield onto an exterior door according to claim 2, wherein forcing said moisture shield against said exterior door causes said adhesive to wet out between said moisture shield and said exterior door.

4. The method of installing an interior panel and a moisture shield onto an exterior door according to claim 1, wherein said interior panel, said foam member and said moisture shield comprise a pre-assembled module for subsequent installation onto said exterior door.

5. The method of installing an interior panel and a moisture shield onto an exterior door according to claim 1, wherein said thickness of said foam member further varies to correspond with a geometry of accessories disposed on an exterior-facing side of said interior panel.

6. The method of installing an interior panel and a moisture shield onto an exterior door according to claim 1, wherein said foam member is formed from polyurethane foam.

7. The method of installing an interior panel and a moisture shield onto an exterior door according to claim 1, wherein said foam member includes an outer periphery and an inner periphery.

8. The method of installing an interior panel and a moisture shield onto an exterior door according to claim 1, wherein said foam member forms a continuous loop.

9. The method of installing an interior panel and a moisture shield onto an exterior door according to claim 1, wherein said moisture shield includes a flat profile.

10. The method of installing an interior panel and a moisture shield onto an exterior door according to claim 1, wherein a foam block is fixed to a side of said moisture shield.

11. The method of installing an interior panel and a moisture shield onto an exterior door according to claim 1, wherein a sound absorbent member is mounted between said interior panel and said exterior door.

12. The method of installing an interior panel and a moisture shield onto an exterior door according to claim 1, wherein said foam member is press fit into said interior panel.

13. The method of installing an interior panel and a moisture shield onto an exterior door according to claim 1, wherein said moisture shield includes a seal strip that seals against said exterior door.

14. A method of manufacturing a door for a vehicle comprising:
forming an interior panel, an exterior-facing side of said interior panel having a geometry including contours and vehicle accessories disposed thereon;
forming a foam member having a varying thickness coinciding with said geometry of said exterior-facing side of said interior panel, said foam member being resiliently compressible;
retaining a moisture shield against said foam member, an interior-facing side of said moisture shield being adhesively retained against said foam member;
fixing said foam member to said exterior-facing side of said interior panel, said varied thickness of said foam member being aligned with said geometry of said exterior-facing side of said interior panel; and
fixing said interior panel to an exterior panel, said foam member resiliently biasing said moisture shield against an interior-facing side of said exterior door,
wherein said moisture shield, said foam member, and said interior panel form a pre-assembled module prior to fixing said interior panel to said exterior door.

15. The method of manufacturing a door for a vehicle according to claim 14, wherein said foam member forms a continuous loop disposed at a periphery of said moisture shield.

16. The method of manufacturing a door for a vehicle according to claim 14, further comprising an adhesive disposed between said moisture shield and said exterior panel, wherein said foam member biasing said moisture shield against said exterior panel facilitates adhesive wetting therebetween.

17. The method of manufacturing a door for a vehicle according to claim 14, wherein an inner periphery and said outer periphery of said foam member are substantially parallel.

18. The method of manufacturing a door for a vehicle according to claim 14, wherein said moisture shield is a flat panel.

19. The method of manufacturing a door for a vehicle according to claim 14, wherein a foam block is disposed within an inner periphery of said foam member and between said interior panel and said moisture shield.

20. The method of manufacturing a door for a vehicle according to claim 14, wherein a sound absorbent member is disposed on an exterior-facing side of said moisture shield.

21. The method of manufacturing a door for a vehicle according to claim 14, wherein said foam member is press fit into said interior panel.

22. The method of manufacturing a door for a vehicle according to claim 14, wherein said foam member is formed from polyurethane foam.

23. The method of manufacturing a door for a vehicle according to claim 14, further comprising a seal bead disposed on said moisture shield between said moisture shield and said exterior panel, wherein said foam member biasing said moisture shield against said exterior panel facilitates a sealed connection between the seal bead and the exterior panel.

24. A door for a vehicle comprising:
an exterior door panel;
an interior panel fixed to an interior-facing side of said exterior door panel;
a moisture shield disposed between said exterior door panel and said interior panel; and
a foam member disposed between said interior panel and said moisture shield, said foam member resiliently biasing said moisture shield against said interior-facing side of said exterior door panel,
wherein a thickness of said foam member meets a cross-sectional geometry of an exterior-facing side of said interior panel.

25. The door for a vehicle according to claim 24, wherein said foam member uniformly compresses in response to compression of said foam member between said interior panel and said moisture shield.

26. The door for a vehicle according to claim 24, wherein said moisture shield is a flat panel.

27. The door for a vehicle according to claim 24, wherein said foam member resiliently biasing said moisture shield against said interior-facing side of said exterior door panel causes wetting of an adhesive between said moisture shield and said exterior door panel.

28. The door for a vehicle according to claim 24, wherein a sound absorbent member is disposed on an exterior-facing side of said moisture shield.

29. The door for a vehicle according to claim 28, wherein said sound absorbent member is a non-woven fabric.

30. The door for a vehicle according to claim 24, wherein said moisture shield is adhesively bonded to said exterior door panel.

31. The door for a vehicle according to claim 24, wherein said foam member is press fit into said interior panel.

32. The door for a vehicle according to claim 24, wherein said foam member is formed from polyurethane foam.
